(19) United States
(12) Patent Application Publication
(10) Pub. No.: US 2014/0316781 A1
(43) Pub. Date: Oct. 23, 2014

(54) WIRELESS TERMINAL AND INFORMATION PROCESSING METHOD OF THE WIRELESS TERMINAL

(71) Applicant: INFOBANK CORP., Seongnam-si, Gyeonggi-do (KR)

(72) Inventors: Jun ho Jang, Seongnam-si (KR); Tae hyung Park, Seoul (KR); Seong jin Ahn, Seoul (KR)

(73) Assignee: INFOBANK CORP., Seongnam-si, Gyeonggi-si, Gyeonggi-do (KR)

(21) Appl. No.: 14/366,415

(22) PCT Filed: Dec. 18, 2012
(86) PCT No.: PCT/KR2012/011113

§ 371 Date: Jun. 18, 2014

(30) Foreign Application Priority Data
Dec. 18, 2011 (KR) 10-2011-0136906
Dec. 18, 2011 (KR) 10-2011-0136907
Dec. 18, 2011 (KR) 10-2011-0136908
Dec. 18, 2011 (KR) 10-2011-0136909

(51) Int. Cl. G10L 17/22; G10L 13/04; G10L 15/26

(52) U.S. Cl. CPC G10L 17/22; G10L 15/26; G10L 13/04
USPC 704/235

(57) ABSTRACT

The present invention relates to a wireless terminal, an information processing method and a recording medium. The wireless terminal according to the present invention comprises a short-range communication section for connecting a short-range communication channel with a communication apparatus included in a vehicle; a checking section for checking whether the wireless terminal is positioned in the vehicle, based on connection information of the short-range communication channel through the short-range communication section; a first converting section for converting text information received through one of N applications for transceiving text information into speech information, the applications being included in the wireless terminal, in the case that the wireless terminal is positioned in the vehicle, according to a result of the checking by the checking section; a processing section for outputting the converted speech information through a speaker of the wireless terminal; an input section for receiving speech information from a user of the wireless terminal; and a second converting section for converting the received speech information into text information. The processing section transmits the converted text information through the application for transceiving text information.

### TECHNICAL FIELD

The present invention relates to a wireless terminal and an information processing method of the wireless terminal for checking whether a wireless terminal is positioned in a vehicle, converting text information transmitted to the wireless terminal into speech information and outputting the converted speech information, and converting speech information input through the wireless terminal into the text information and transmitting the converted text information.

### BACKGROUND ART

In recent, with active supply of mobile messengers, prior e-mail applications, SMS (short message service) applications, and various IM (Instant Messenger) applications such as KakaoTalk, etc. has been established as a text information receiving means, and therefore a user has been various kinds of text information receiving means, more than one to two, on a wireless terminal.

However, when the user is driving, various text information receiving means sometimes receive the text information and therefore causes risks due to drivers' gaze dispersion on driving.

On the other hand, with the development of a TTS (Text to Speech) engine for converting the text information into the speech information and a STT (Speech to Text) engine for converting the speech information into the text information, the user outputs the text information received into the wireless terminal into the speech information and may listen to the outputted speech information, and when the user inputs speech information, it is converted into the text information to transmit it.

An apparatus and method for recognizing a user's speech are disclosed in Korea Patent Application Publication No. 10-2001-0086402 (Title: speech recognition apparatus), and An apparatus and method for synthesizing specific sentences with random speech are disclosed in Korea Patent Application Publication No. 10-2002-0094988 (Title: speech synthesizing method, and speech synthesizing apparatus for embodying the same).

However, although the TTS engine and STT engine are disposed in the wireless terminal, the user drives the TTS engine and STT engine on receiving the text information one by one, and there is a case for forgetting the driving of the TTS engine and STT engine on driving, thereby to become them as titular functions.

### DISCLOSURE OF INVENTION

### Technical Problem

An object of the present invention for solving the above-mentioned problems is providing a wireless terminal, an information processing method in the wireless terminal and a computer-readable recording medium for programs to execute information processing for solving the inconvenience in that the user rides on a vehicle one by one and directly processes the driving of TTS engine and STT engine and, simultaneously, for fundamentally blocking dangerous situations that attention and action of a driver are focused on the wireless terminal on receiving text information while forgetting the driving of the TTS engine and STT engine on driving by automatically driving the TTS engine and STT engine, in case the wireless terminal is positioned in the vehicle, after checking whether the wireless terminal is positioned in the vehicle.

Also, another object of the present invention for solving the above-mentioned problems is providing a wireless terminal, an information processing method in the wireless terminal and a computer-readable recording medium for programs to execute information processing for solving the inconvenience in that the user rides on a vehicle one by one and directly processes the driving of TTS engine and STT engine and, simultaneously, for fundamentally blocking dangerous situations that attention and action of a driver are focused on the wireless terminal on receiving text information while forgetting the driving of the TTS engine and STT engine on driving by automatically driving the TTS engine and STT engine and outputting the converted speech information thorough a hands-free device or communication apparatus of the vehicle connected to the wireless terminal using a short-range communication channel, in case the wireless terminal is positioned in the vehicle, after checking whether the wireless terminal is positioned in the vehicle.

### Solution to Problem

A wireless terminal according to an aspect of the invention includes a short-range communication section for connecting a short-range communication channel with a communication apparatus included in a vehicle; a checking section for checking whether the wireless terminal is positioned in the vehicle, based on connection information of the short-range communication channel through the short-range communication section; a first converting section for converting text information received through one of N applications for transceiving text information into speech information, the applications being included in the wireless terminal, in case the wireless terminal is positioned in the vehicle, according to a result of the checking by the checking section; and a processing section for outputting the converted speech information through a speaker of the wireless terminal; an input section for receiving speech information from a user of the wireless terminal; and a second converting section for converting the received speech information into text information. And, the processing section transmits the converted text information through the application for transceiving text information.

An image processing method in a wireless terminal according to an aspect of the invention includes connecting a short-range communication channel with a communication apparatus included in a vehicle; checking whether the wireless terminal is positioned in a vehicle, based on connection information of the short-range communication channel through the connecting; converting text information received through one of N applications for transceiving text information into speech information, the applications being included in the wireless terminal, in case the wireless terminal is positioned in the vehicle, according to a result of the checking by the checking section; outputting the converted speech information through a speaker of the wireless terminal; receiving speech information from a user of the wireless terminal; converting the received speech information into text information; and transmitting the converted text information through the application for transceiving text information.

A wireless terminal according to another aspect of the invention includes a checking section for checking whether the wireless terminal is positioned in a vehicle, based on connection information of a short-range communication channel with a communication apparatus included in the vehicle. And, the wireless terminal converts the text information received through one of the applications included in the wireless terminal into speech information in case the wireless terminal is positioned in the vehicle, according to a result of the checking by the checking section, and then outputs the converted speech information through a speaker of the wireless terminal.

A wireless terminal according to another aspect of the invention includes a short-range communication section for connecting a short-range communication channel with a communication apparatus included in a vehicle; a checking section for checking whether the wireless terminal is positioned in the vehicle, based on connection information of the short-range communication channel through the short-range communication section; a converting section for converting the text information received through one of the applications included in the wireless terminal into speech information in case the wireless terminal is positioned in the vehicle, according to a result of the checking by the checking section; and a processing section for outputting the converted speech information through a speaker of the wireless terminal.

An image processing method in a wireless terminal according to another aspect of the invention includes connecting a short-range communication channel with a communication apparatus included in a vehicle; checking whether the wireless terminal is positioned in the vehicle, based on connection information of the short-range communication channel through the short-range communication section; converting text information received through one of the N applications for transceiving text information into speech information, the applications being included in the wireless terminal, in case the wireless terminal is positioned in the vehicle, according to a result of the checking by the checking section; and outputting the converted speech information through a speaker of the wireless terminal.

A wireless terminal according to another aspect of the invention includes a short-range communication section for connecting a short-range communication channel with a communication apparatus or a hands-free device included in a vehicle; a checking section for checking whether the wireless terminal is positioned in the vehicle, based on connection information of the short-range communication channel through the short-range communication section; a first converting section for converting text information received through one of N applications for transceiving text information into speech information, the applications being included in the wireless terminal, in case the wireless terminal is positioned in the vehicle, according to a result of the checking by the checking section; a short-range communication section for connecting a short-range communication channel with a hands-free device or a communication apparatus for the vehicle; a processing section for transmitting the converted speech information through the short-range communication channel connected by the short-range communication section and outputting the converted speech information through the hands-free device or the communication apparatus for the vehicle; an input section for receiving speech information of the wireless terminal's user through the short-range communication channel connected by the short-range communication section; and a second converting section for converting the received speech information into text information. And, the processing section transmits the converted text information through the application for transceiving text information.

An image processing method in a wireless terminal according to another aspect of the invention includes connecting a short-range communication channel with a communication apparatus or a hands-free device included in a vehicle; checking whether the wireless terminal is positioned in the vehicle, based on connection information of the short-range communication channel through the short-range communication section; converting text information received through one of N applications for transceiving text information into speech information, the applications being included in the wireless terminal, in case the wireless terminal is positioned in the vehicle, according to a result of the checking by the checking section; checking whether a hands-free device or a communication apparatus for the vehicle are activated, the hands-free device and the communication apparatus being connected to the wireless terminal using short-range communication, and activating the hands-free device or the communication apparatus if not activated; transmitting the converted speech information to the activated hands-free device or the communication apparatus through the short-range communication channel and outputting the converted speech information through the hands-free device or the communication apparatus for the vehicle; receiving speech information of the wireless terminal's user through the short-range communication channel connected by the short-range communication section; converting section for converting the received speech information into text information; and transmitting the converted text information through the application for transceiving text information.

A wireless terminal according to another aspect of the invention includes a checking section for checking whether the wireless terminal is positioned in the vehicle, based on connection information of the short-range communication channel with a communication apparatus included in the vehicle. And, the wireless terminal converts text information received through one of the N applications included in the wireless terminal into speech information, in case the wireless terminal is positioned in the vehicle, according to a result of the checking by the checking section, checks whether a hands-free device or a communication apparatus for the vehicle are activated, the hands-free device and the communication apparatus being connected to the wireless terminal using short-range communication, and activates the hands-free device or the communication apparatus if not activated, and transmits the converted speech information to the activated hands-free device or the communication apparatus through the short-range communication channel and outputs the converted speech information through the hands-free device or the communication apparatus for the vehicle.

A wireless terminal according to another aspect of the invention includes a short-range communication section for connecting a short-range communication channel with a communication apparatus or a hands-free device included in a vehicle; a checking section for checking whether the wireless terminal is positioned in the vehicle, based on connection information of the short-range communication channel through the short-range communication section; a converting section for converting text information received through one of the N applications included in the wireless terminal into speech information, in case the wireless terminal is positioned in the vehicle, according to a result of the checking by the checking section; a short-range communication section for connecting a short-range communication channel with a hands-free device or a communication apparatus for the vehicle; and a processing section for transmitting the converted speech information through the short-range communication channel connected by the short-range communication section and outputting the converted speech information through the hands-free device or the communication apparatus for the vehicle.

An image processing method in a wireless terminal according to another aspect of the invention includes connecting a short-range communication channel with a communication apparatus or a hands-free device included in a vehicle; checking whether the wireless terminal is positioned in the vehicle, based on connection information of the short-range communication channel through the connecting; converting text information received through one of N applications for transceiving text information into speech information, the applications being included in the wireless terminal, in case the wireless terminal is positioned in the vehicle, according to a result of the checking by the checking section; checking whether a hands-free device or a communication apparatus for the vehicle are activated, the hands-free device and the communication apparatus being connected to the wireless terminal using short-range communication, and activating the hands-free device or the communication apparatus if not activated; and transmitting the converted speech information to the activated hands-free device or the communication apparatus through the short-range communication channel and outputting the converted speech information through the hands-free device or the communication apparatus for the vehicle.

### Advantageous Effects of Invention

According to an embodiment of the present invention, the present invention automatically drives TTS engine and STT engine after checking whether the wireless terminal is positioned in a vehicle, thereby to solve the inconvenience in that the user rides on the vehicle one by one and directly processes the driving of TTS engine and STT engine and, simultaneously, to fundamentally block dangerous situations that attention and action of a driver are focused on the wireless terminal on receiving the text information while forgetting the driving of the TTS engine and STT engine on driving.

Further, according to another embodiment of the present invention, the present invention outputs the converted speech information through the hands-free device or communication apparatus disposed in the vehicle, not a speaker of the wireless terminal, and receives a user's reply speech information through the hands-free device or communication apparatus disposed in the vehicle, not a microphone of the wireless terminal, thereby to perform smooth services by the wireless terminal in pockets of clothes and to enhance quality of service by using a speaker or microphone having remarkable performance as compared with the speaker or microphone of the wireless terminal.

Further, according to another embodiment of the present invention, the wireless terminal's user can set and register an application for converting the received text information into speech information among various kinds of text information transceiving applications and information of items to be converted into speech information using a single UI (User Interface). Therefore, the user can use speech information conversion service for text information more easily and conveniently. And, the present invention has economic effect that does not install the TTS engine or STT engine for each of text information transceiving applications.

### BRIEF DESCRIPTION OF THE DRAWINGS

The following drawing drawings attached to the present specification illustrate an exemplary embodiment of the invention, and serves to further understand the technical idea of the invention along with a detailed description of the invention. Therefore, the invention is not limited to matters described in the drawings.

FIG. 1 shows configurations of the entire communication network according to an embodiment of the present invention.

FIG. 2 shows configurations of an user's wireless terminal according to the embodiment of the present invention.

FIG. 3 shows UI (User Interface) according to the embodiment of the present invention.

FIG. 4 shows a process for converting and outputting text information to speech information, after checking whether a wireless terminal is located in a vehicle, according to the embodiment of the present invention.

FIG. 5 shows a process for checking whether a wireless terminal is positioned in a vehicle, according to the embodiment of the present invention.

FIG. 6 shows a process for extracting text information corresponding to pre-registered application information, according to the embodiment of the present invention.

FIG. 7 shows a process for converting and outputting text information corresponding to pre-registered application information and item information into speech information, according to the embodiment of the present invention.

FIG. 8 shows a process for converting and transmitting a user's reply speech information into the text information, according to the embodiment of the present invention.

FIG. 9 shows one example according to the embodiment of the present invention.

FIG. 10 shows a process for converting text the information into the speech information and outputting it, after checking whether the wireless terminal is located in the vehicle, according to the embodiment of the present invention.

FIG. 11 shows a process for converting and outputting text information corresponding to pre-registered application information and item information into speech information, according to the embodiment of the present invention.

FIG. 12 shows a process for converting and transmitting a user's reply speech information into the text information, according to the embodiment of the present invention.

### DESCRIPTION OF THE PREFERRED EMBODIMENTS

Hereinabove, although the present invention is described by specific matters such as concrete components, and the like, embodiments, and drawings, they are provided only for assisting in the entire understanding of the present invention. The specified matters and embodiments and drawings such as specific apparatus drawings of the present invention have been disclosed for illustrative purposes, but are not limited thereto, and those skilled in the art will appreciate that various modifications, additions and substitutions are possible from the disclosure in the art to which the present invention belongs. In describing exemplary embodiments of the present invention, well-known functions or constructions will not be described in detail since they may unnecessarily obscure the understanding of the present invention. Further, the terminologies specifically defined in consideration of the configuration and functions of the present invention may be construed in different ways by the intention of users and operators. Therefore, the definitions thereof should be construed based on the contents throughout the specification. Therefore, the definitions thereof should be construed based on the contents throughout the specification.

It will be apparent to those skilled in the art that substitutions, modifications and variations can be made without departing from the spirit and scope of the invention as defined by the appended claims and can also belong to the scope of the invention.

First, a first embodiment of the present invention will be described.

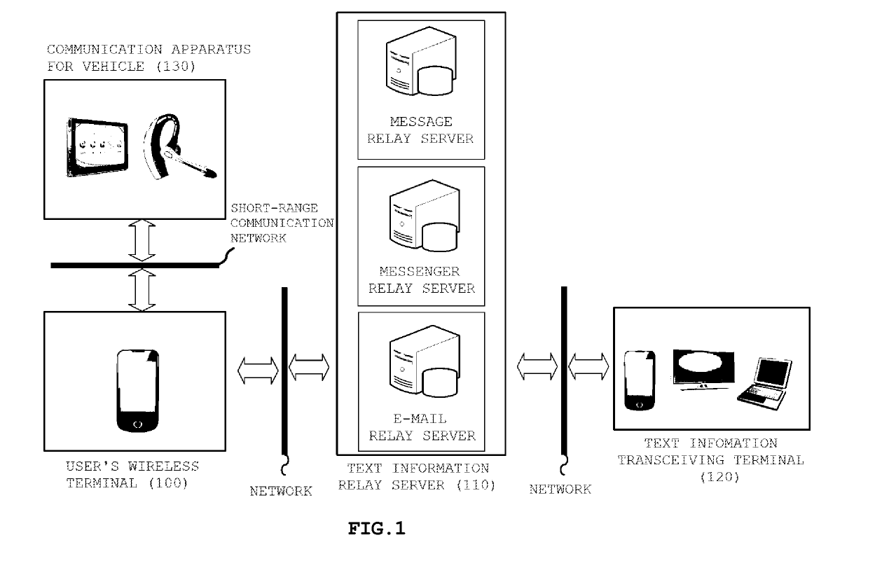

FIG. 1 shows configurations of the entire communication network according to an embodiment of the present invention.

In more detail, FIG. 1 shows the configurations that a user's wireless terminal 100 is connected to one or more text information relay servers 110 corresponding to a plurality of applications for transceiving text information through a network, receives text information transmitted from a text information transceiving terminal 120, checks whether the wireless terminal 100 is positioned in a vehicle by using connection of a short-range communication channel with a communication apparatus for the vehicle over the short-range communication network, and then outputs the text information to speech information through a speaker of the wireless terminal 100.

The text information relay server 110 according to the present invention performs a role of transmitting the text information transmitted from the text information transceiving terminal 120 to the wireless terminal 100, and transmitting the text information transmitted from the wireless terminal 100 to the text information transceiving terminal 120.

According to the present invention, the text information relay server 110 may be a server of a message service center on the network, in case that the text information transceiving application installed in the wireless terminal 100 is a message transceiving application including at least one of SMS(Short Message Service), LMS (Long Message Service) and MMS (Multimedia Message Services). And, the text information relay server 110 may be an e-mail relay server on the network, in case that the text information transceiving application installed in the wireless terminal 100 is an e-mail application. And, the text information relay server 110 may be a relay server for providing and operating each of messenger applications, in case that the text information transceiving application installed in the wireless terminal 100 is an instant messenger application. And, the text information relay server 110 may be a relay server for providing and operating each of SNS (Social Networking Service) applications, in case that the text information transceiving application installed in the wireless terminal 100 is a SNS application.

The text information transceiving terminal 120 in the present invention transmits messages including at least one of SMS, LMS, MMS or e-mails to the user's wireless terminal 100, or means a terminal for performing messenger or SNS to the user's wireless terminal 100, and includes all terminals, capable of transmitting and receiving texts, such as a mobile phone, a smartphone, a tablet PC, PC, telematics, etc.

The wireless terminal 100 according to the present invention checks whether the wireless terminal 100 is positioned in the vehicle by receiving connection information of the short-range communication channel between the wireless terminal 100 and the communication apparatus 130 from the communication apparatus 130 included in the vehicle, or receiving a signal corresponding to log-in information of the wireless terminal 100 from the communication apparatus 100 when the wireless terminal 100 logs in the communication apparatus 130, or paring a bluetooth device included in the wireless terminal 100 with a bluetooth device included in the vehicle, or receiving information whether the wireless terminal 100 is positioned in the vehicle directly from the communication apparatus 130, or receiving connection information of the wireless terminal's charger terminals to a power supply device included in the vehicle through the communication apparatus 130. And, then if the wireless terminal 100 is positioned in the vehicle, the wireless terminal 100 converts text information received through one among first to N-th text information transceiving applications installed in the wireless terminal 100 into speech information, outputs the converted speech information through a speaker equipped in the wireless terminal 100. And, if reply speech information is input by the wireless terminal's user, after converting the input speech information into text information, the wireless terminal 100 transmits the converted text information to the text information transceiving terminal that transmitted the text information to the wireless terminal 100 through the text information transceiving application.

Also, the wireless terminal 100 provides an interface for selecting one or more among the N applications for transceiving text information to the user, stores and registers earlier information of the applications that the wireless terminal's user selects through the interface in a memory 220. And, the wireless terminal 100 checks whether the wireless terminal 100 is positioned in the vehicle, and determining whether a function for extracting text information received through the stored and registered application is activated or not according to a result of the checking. Afterward, in case that text information is received to the N applications, if the application receiving the text information is an application stored and registered in the memory 220, the wireless terminal 100 extracts the text information received by the application stored and registered in the memory 220 or receives through the application.

Also, the wireless terminal 100 further performs a role of receiving a selection of item to be converted into speech information among text information received by the selected application. In this case, the wireless terminal 100 connects information of the item selected through the interface with information of the selected application, and stores and registers the connected information in the memory 220. And, if text information is received to the N applications, after checking the item information connected with the selected application in the memory 220, the wireless terminal 100 selectively extracts or receives text information corresponding to the item information among the received text information.

Here, the item information may include at least one of message transmitter information and message content information in case the application is a message transceiving application including one or more of SMS (Short Message Service), LMS (Long Message Service) and MMS (Multimedia Message Services). And, the item information may include at least one of e-mail transmitter information, e-mail title information and e-mail body content information in case the application is an application for transceiving e-mail. And, the item information may include at least one of messenger user information and messenger content information in case the application is an instant messenger application.

Here, the text information transceiving application according to the present invention may include one or more of a message transceiving application including at least one of SMS (Short Message Service), LMS (Long Message Service) and MMS (Multimedia Message Services), an e-mail transceiving application, an instant messenger application and a SNS application. And, the text information may include at least one of message transmitter information and message content information in case the application is a message transceiving application including one or more of SMS, LMS and MMS. And, the text information may further include at least one of e-mail transmitter information, e-mail title information and e-mail body content information, in case the application is an application for transceiving e-mail. And, the text information may further include at least one of messenger user information and messenger content information, in case the application is an instant messenger application. And, the text information may further include at least one of user ID information and content information, in case that the application is a SNS application.

According to the present invention, the communication apparatus for the vehicle 130 is connected with the wireless terminal 100 using the short-range communication (for example, any short-range communication including Bluetooth communication and Wi-Fi communication, etc.). Therefore, the communication apparatus for the vehicle 130 may transmit the connection information of the short-range communication channel between the wireless terminal 100 and the communication apparatus 130 to the wireless terminal 100, or transmit a signal corresponding to log-in information to the wireless terminal 100 when the wireless terminal 100 logs in the communication apparatus 130, or transmit paring information between the bluetooth device included in the wireless terminal 100 and the bluetooth device included in the vehicle to the wireless terminal 100, or transmit information whether the wireless terminal 100 is positioned in the vehicle directly to the wireless terminal 100, or transmit connection information of the wireless terminal's charger terminals to a power supply device included in the vehicle to the wireless terminal 100 for checking whether the wireless terminal 100 positioned in the vehicle.

According to the present invention, the communication apparatus for the vehicle 130 may comprise at least one of a telematics apparatus for the vehicle, an audio apparatus for the vehicle, a bluetooth device for the vehicle and a hands-free device for the vehicle.

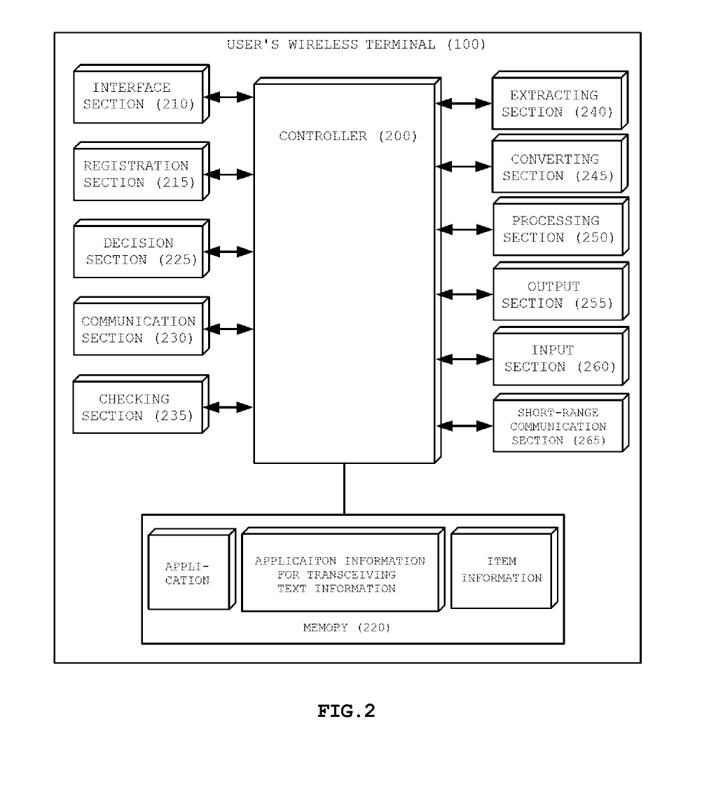

FIG. 2 shows configurations of the wireless terminal 100 according to an embodiment of the present invention.

The wireless terminal 100 operated on mobile communication and communication system is applied to image processing according to the present invention, although a detailed illustration is omitted on FIG. 2, the wireless terminal 100 may include an outward body, a speaker, a microphone, a keypad, LCD (Liquid Crystal Display), an antenna, a battery, and all functions and elements that can be included in the wireless terminal 100 for communication the here and the hereafter.

Preferably, main functional components of the wireless terminal 100 according to the present invention, as shown in FIG. 2, may comprise an interface section 210, a registration section 215, a memory 220, a decision section 225, a communication section 230, a checking section 235, an extracting section 240, a converting section 245, a processing section 250, an output section 255, an input section 260, a short-range communication section 265 and a controller 200 controlling each of the components and a program. According to types and characteristics of the wireless terminal 100 and a skilled person's implement method, one or more components may be added or omitted.

For example, in case the function for conversion and outputting text information to speech information and the function for conversion and outputting speech information to text information are equipped directly in one of the text information transceiving applications, the interface section 210, the registration section 215 and the extracting section 240 may be omitted.

Referring to FIG. 2, the interface section 210 performs a role of providing an interface for selecting one or more of the first to N-th applications for transceiving text information, the applications being included in the wireless terminal 100.

That is, the interface section 210 checks one or more applications having the function for transceiving text information among many applications installed in the wireless terminal 100, outputs the checked applications on a screen of the interface, and then support the user to select an application for converting text information into speech information or speech information into text information through the screen of the interface.

Also, the interface section 210, besides the selection of the text information transceiving application from the user, may receive a selection of item to be converted into speech information among text information received by each of the applications selected from the user.

Here, the item information may include at least one of message transmitter information and message content information in case the application is a message transceiving application including one or more of SMS (Short Message Service), LMS (Long Message Service) and MMS (Multimedia Message Services). And, the item information may include at least one of e-mail transmitter information, e-mail title information and e-mail body content information in case the application is an application for transceiving e-mail. And, the item information may include at least one of messenger user information and messenger content information in case the application is an instant messenger application.

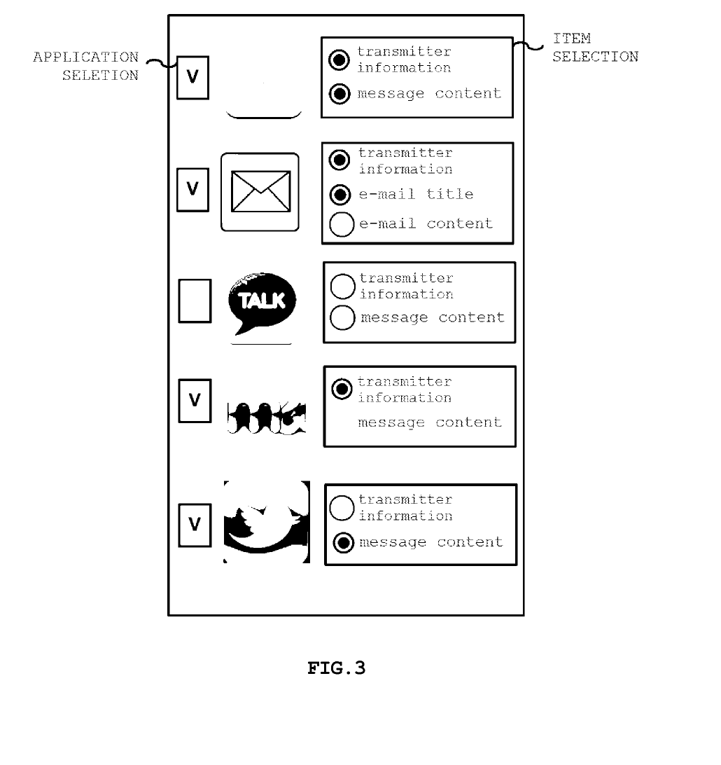

FIG. 3 shows an embodiment of the interface screen according to the present invention. As shown in FIG. 3, the interface section 210 outputs five applications having the function for transceiving text information among a plurality of applications currently installed in the wireless terminal 100 on the interface screen. The five applications include a message transceiving application, an e-mail transceiving application, a KakaoTalk application and an M& application that are messenger applications, and a Twitter application that is a SNS application. So, it enables the user to select a target application for converting and output the received text information to speech information among the five applications, and select the item to be converted to speech information among the text information received by each of the selected applications at the same time.

For example, in case of the SMS application, if text information such as SMS is received, the user can select message transmitter information and message content information as the item to be converted into speech information. In case of the e-mail application, the user can select e-mail transmitter information and e-mail title information, except for e-mail content, as the item to be converted into speech information. In case of the M& messenger application, the user can select only transmitter information of a conversation partner as the item to be converted into speech information.

Here, the transmitter information is name information of the transmitter recorded in a contact list, or CID (Calling Identification Display) information, or ID information, or e-mail address information.

The registration section 215 according to the present invention performs a role of connecting information of the one or more applications selected by the user through the interface section 210 with information of the item corresponding to each of the selected applications, and storing the connected information in the memory 220.

The memory 220 according to the present invention performs a role of storing the information of the one or more applications selected by the user and the information of the item corresponding to each of the selected applications.

And, the memory 220, which is a collective name of memory elements for storing a predetermined program routine (or code) and/or program data (for example, information and/or data inputted and outputted when operations by the program routine (or code) is performed) for controlling whole operations of the wireless terminal 100, includes ROM (Read Only memory) corresponding to read only memory, readable/writable Flash Memory (FM), and EEPROM (Electrically Erasable and Programmable Read Only Memory), etc.

The short-range communication section 265 according to the present invention performs a role of connecting the short-range communication channel between the communication apparatus 130 included in the vehicle and the wireless terminal 100.

The checking section 235 according to the present invention performs a role of checking whether the wireless terminal 100 is positioned in the vehicle, by receiving connection information of the short-range communication channel between the wireless terminal 100 and the communication apparatus 130 from the communication apparatus 130 included in the vehicle, or receiving a signal corresponding to log-in information of the wireless terminal 100 from the communication apparatus 100 when the wireless terminal 100 logs in the communication apparatus 130, or paring a bluetooth device included in the wireless terminal 100 with a bluetooth device included in the vehicle, or receiving information whether the wireless terminal 100 is positioned in the vehicle directly from the communication apparatus 130, or receiving connection information of the wireless terminal's charger terminals to a power supply device included in the vehicle through the communication apparatus 130. And, then if the wireless terminal 100 is positioned in the vehicle, the wireless terminal 100 converts text information received through one among first to N-th text information transceiving applications installed in the wireless terminal 100 into speech information, outputs the converted speech information through a speaker equipped in the wireless terminal 100.

Also, according to another embodiment of the invention, the checking section 235, in case text information is received by the communication section 230, further performs a role of checking whether an application receiving the text information is a text information transceiving application already stored and registered in the memory 220.

The decision section 225 according to the present invention, in case whether the wireless terminal 100 is positioned in the vehicle and whether the application receiving the text information is a text information transceiving application already stored and registered in the memory 220 are checked, performs a role of deciding activation or deactivation of the extracting section's function according to a result of the checking by the checking section 235.

That is, the decision section decides activation or deactivation of the extracting section's function, for performing the role of converting the received text information into speech information only on the user's preferred conditions and environments to solve a problem (for example, a problem that auto-converted speech is output at a public place) by converting the received text information into speech information every time text information is received.

The controller 200 according to the present invention controls activation or deactivation of the extracting section's function according to a result of the decision by the decision section 225.

The communication section 230 according to the present invention receives various kind of text information received to the wireless terminal 100 and transmits various kind of text information from the wireless terminal 100.

The extracting section 240 according to the present invention is activated by the controller 200, and then extracts the text information received by the text information transceiving application or is delivered the text information from the text information transceiving application in case the text information is received to the first to N-th text information transceiving applications through the communication section 230 and whether the wireless terminal 100 is positioned in the vehicle is checked by the checking section 235.

Also, the extracting section 240, in case item information connected with the text information transceiving application is already stored and registered in the memory 220, may extract text information (for example, transmitter information or e-mail title information) corresponding to the item information among the received text information or is delivered the text information corresponding to the item information from the text information transceiving application.

The converting section 245 according to the present invention performs a role of converting the text information extracted or delivered through the extracting section 240 into speech information.

Also, if speech information of the user's reply is input through a microphone included in the wireless terminal 100 at a subsequent process, the converting section 245 converts the input speech information into text information.

According to the present invention, although the component of the converting section 245 is shown as a single component in FIG. 2, the converting section 245 may be separately composed of a first converting section 245(1) converting text information into speech information and a second converting section 245(2) converting speech information into text information according to a skilled person's implement method.

According to the present invention, the converting section 245 may convert texts including emotion represented as various special characters such as “̂̂”, “˜˜”, “);;”, etc. of the text information into the speech information corresponding to the emotion, that is, “haha”, and on the contrary, may convert the speech information, inputted by a user, including “haha” into the text information, that is, “̂̂” including the special character.

And, the converting section 245 may differ a size of text converted according to a size of speech and the size of the speech according to the size of the received text, on converting emotional expression including such a special character into the speech or text.

Main functions of the converting section 245 of the present invention, that is, a TTS (Text to Speech) function for converting the text information into the speech information and a STT (Speech to Text) function for converting the speech information into the text information uses functions of a prior TTS engine and STT engine or functions of a TTS engine and STT engine to be developed later. Therefore, since they do not become a principal idea of the present invention, the detailed description about them will be omitted.

The processing section 250 according to the present invention processes the speech information converted through the converting section 245 such that the converted speech information is output through a speaker included in the wireless terminal 100.

Further, the processing section 250, if speech information corresponding to the user's reply is input through a microphone included in the wireless terminal 100 and the input speech information is converted into the text information by the converting section 245, transmits the converted text information to the text information transceiving terminal 120.

The output section 255 and the input section 260 outputs the speech information and inputs the user's speech information on each, and a speaker and a microphone correspond to them.

According to the present invention, at least one of functions for each configuration disposed in the wireless terminal 100 may be implemented by an application that is a kind of a program installed in the wireless terminal 100.

In this case, the application may perform at least one of functions providing an interface for selecting one or more of the N applications for transceiving text information, storing and registering information of one or more applications selected by the wireless terminal's user through the interface in the memory 220, checking whether the wireless terminal 100 is positioned in the vehicle, deciding activation or deactivation of a function extracting the text information received by the text information transceiving application that is stored and registered in the memory 220. And, the application may further perform a function extracting the text information received by the text information transceiving application stored and registered in the memory 220 or receiving the text information from the text information transceiving application in case the text information is received to the first to N-th text information transceiving applications and the text information transceiving application is stored and registered in the memory 220. Also, the application may further perform at least one of functions converting the extracted or received text information into speech information, processing the converted speech information to be output through the speaker included in the wireless terminal 100, receiving speech information of the wireless terminal's user, converting the input speech information into text information, and processing the converted text information to be transmitted through the text information transceiving application.

Hereinafter, each information processing process in the present invention will be described in more detail.

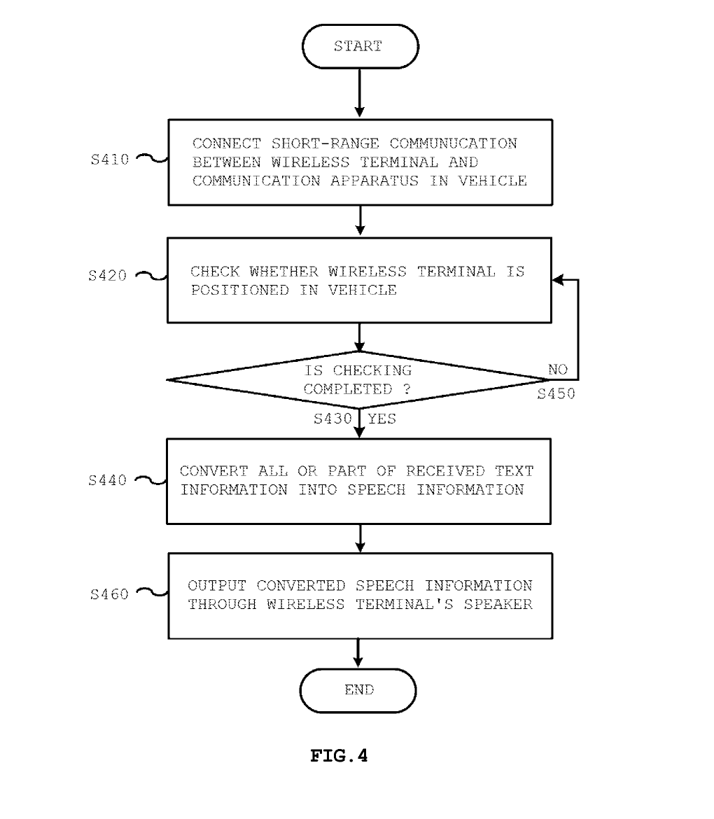

FIG. 4 shows the process for converting and outputting the text information to the speech information after checking whether the wireless terminal 100 is positioned in the vehicle according to an embodiment of the present invention.

Firstly, the wireless terminal 100 connects the short-range communication channel with the communication apparatus 130 or a hands-free device included in the vehicle using the short-range communication (S410).

Although the step S410 is before a step S420 in FIG. 4, the step S410 may be after the step S420 and before transmitting the converted speech information to the communication apparatus 130 or the hands-free device included in the vehicle.

Then, the wireless terminal 100 checks whether the wireless terminal 100 is positioned in the vehicle using the checking section 235 (S420).

Here, the checking section 235 may check whether the wireless terminal 100 is positioned in the vehicle by receiving connection information of the short-range communication channel between the wireless terminal 100 and the communication apparatus 130 from the communication apparatus 130 included in the vehicle, or receiving a signal corresponding to log-in information of the wireless terminal 100 from the communication apparatus 100 when the wireless terminal 100 logs in the communication apparatus 130, or paring a bluetooth device included in the wireless terminal 100 with a bluetooth device included in the vehicle, or receiving information whether the wireless terminal 100 is positioned in the vehicle directly from the communication apparatus 130, or receiving connection information of the wireless terminal's charger terminals to a power supply device included in the vehicle through the communication apparatus 130. And, then if the wireless terminal 100 is positioned in the vehicle, the wireless terminal 100 converts text information received through one among first to N-th text information transceiving applications installed in the wireless terminal 100 into speech information, outputs the converted speech information through a speaker equipped in the wireless terminal 100.

When it checks whether the wireless terminal 100 is positioned in the vehicle at the step S420 (S430), the wireless terminal 100 converts all or items corresponding to partial item information of text information received to the wireless terminal 100 into speech information (S440).

When it does not check whether the wireless terminal 100 is positioned in the vehicle at the step S420 (S450), the wireless terminal 100 outputs the text information received to the wireless terminal 100 on a screen.

Afterward, the wireless terminal 100 outputs the speech information converted in the step 440 through the speaker included in the wireless terminal 100 (S460).

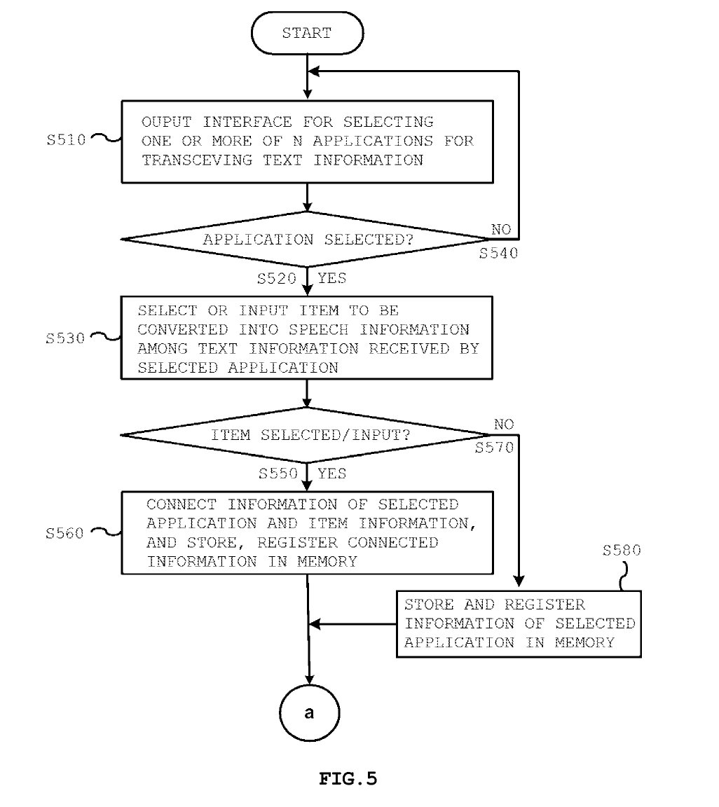

FIG. 5 shows a process for selecting and registering an application for converting text information into speech information among a plurality of text information transceiving applications and item information, according to the embodiment of the present invention.

Firstly, the wireless terminal 100, in response to the user's request, outputs an interface for selecting a specific application or at least one of the first to N-th text information transceiving applications (N=2, 3 . . . N) installed in the wireless terminal 100 on the screen by using the interface section 210 (S510).

In the step S510, the interface screen may output an interface for selecting item information to be converted and output to speech information among text information received by the selected application together with the selection of the application through a single screen.

If the user selects an application in the step S610 (S520), the wireless terminal 100 checks whether the item information to be converted and output to speech information among text information received by the selected application is further selected or input (S530).

If the user does not select an application in the step S610, the wireless terminal 100 terminates the interface screen and waits restart (S540).

If the user selects or inputs the item information to be converted and output to speech information among text information received by the selected application in the step S530 (S550), the wireless terminal 100 connects information of the text information transceiving application selected through the interface with the item information corresponding to each of the applications, and stores and registers the connected information in the memory 220 by using a specific application or the registration section 215 (S560).

If the user does not select or input the item information in the step S530 (S570), the wireless terminal 100 stores and registers the information of the text information transceiving application selected through the interface by using the specific application or the registration section 215 (S580).

The step S580 corresponds to a case that the item information is set with default settings or all of received text information is converted into speech information without distinction of the items.

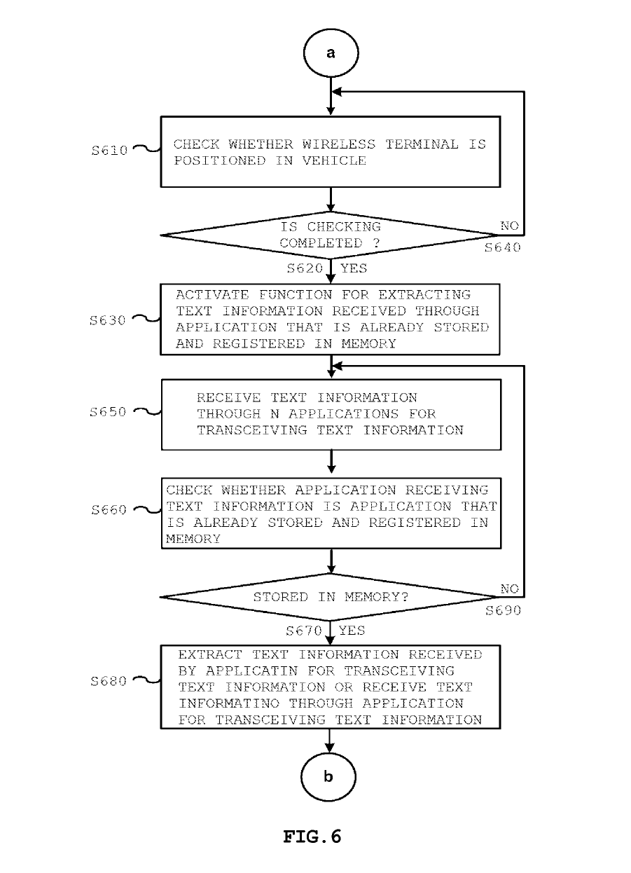

FIG. 6 shows a process for extracting text information corresponding to pre-registered application information, according to the embodiment of the present invention.

Firstly, the wireless terminal 100 checks whether the wireless terminal 100 is positioned in the vehicle by using the checking section 235 (S610).

When it is checked that the wireless terminal 100 is positioned in the vehicle in the step S610 (S620), the wireless terminal's application or controller 200 activates a function for extracting text information received by the text information transceiving application pre-stored and registered in the memory 220 (S630).

If it is not checked that the wireless terminal 100 is positioned in the vehicle in the step S610 (S640), the wireless terminal 100 maintains deactivation of a function for extracting text information received by the text information transceiving application pre-stored and registered in the memory 220 (S650).

Afterward, the wireless terminal 100 receives various kind of text information through the communication section 230 (S650).

Afterward, the wireless terminal 100 checks whether the application receiving the text information is the text information transceiving application pre-stored and registered in the memory 220 by using the specific application or the checking section 235 (S660).

If the application receiving the text information is the text information transceiving application pre-stored and registered in the memory 220 according to a result of the checking in the step S660 (S670), the wireless terminal 100 extracts the text information received by the text information transceiving application pre-stored and registered in the memory 220 through the specific application or the checking section 235 or receives the text information from the text information transceiving application (S680).

If the application receiving the text information is not the text information transceiving application pre-stored and registered in the memory 220 according to a result of the checking in the step S660 (S690), the wireless terminal 100 stands by in the previous step.

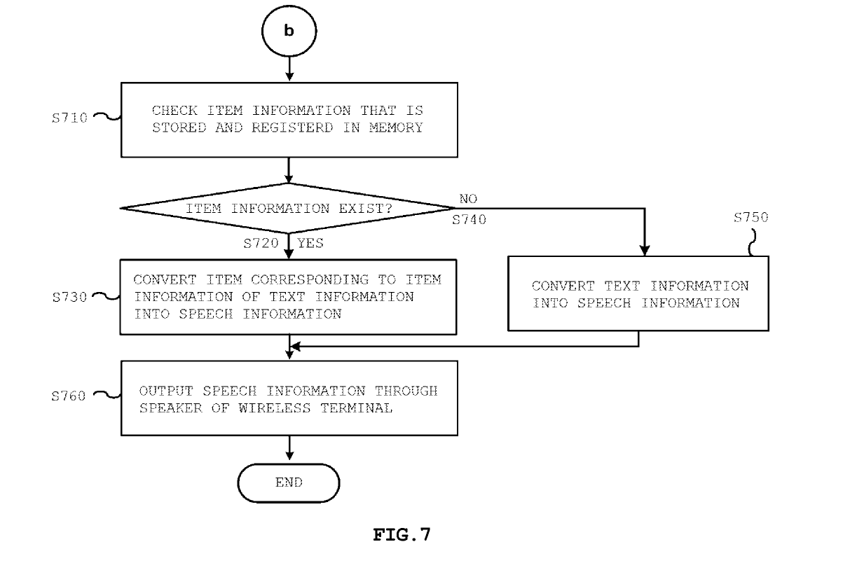

FIG. 7 shows a process for converting and outputting text information corresponding to pre-registered application information and item information into speech information, according to an embodiment of the present invention.

Firstly, the wireless terminal 100 checks Item information connected to the text information transceiving application pre-stored and registered in the memory 220 (S710).

The step S710 is performed after extracting or receiving all of the text information at the step S680 or before the step S680 according to another embodiment of a skilled person. So, only text information corresponding to the item information checked at the step S710 may be selectively extracted or received in the step S680.

If the item information exists (S720), the wireless terminal 100 converts only text information corresponding to the item information among the text information into speech information by using the specific application or the converting section 245 (S730).

If the item information does not exist (S740), the wireless terminal 100 converts all of the text information into speech information by using the specific application or the converting section 245 (S750).

Here, although not shown in the figure, the specific application or the converting section 245 may convert texts including emotion represented as various special characters such as “̂̂”, “˜˜”, “);;”, etc. of the text information into the speech information corresponding to the emotion, that is, “haha”. And, the converting section 245 may differ the size of the speech according to the size of the received text, on converting emotional expression including such a special character into the speech or text.

Afterward, the wireless terminal 100 outputs the converted speech information through the speaker included in the wireless terminal 100 by using the specific application or the processing section 250 (S760).

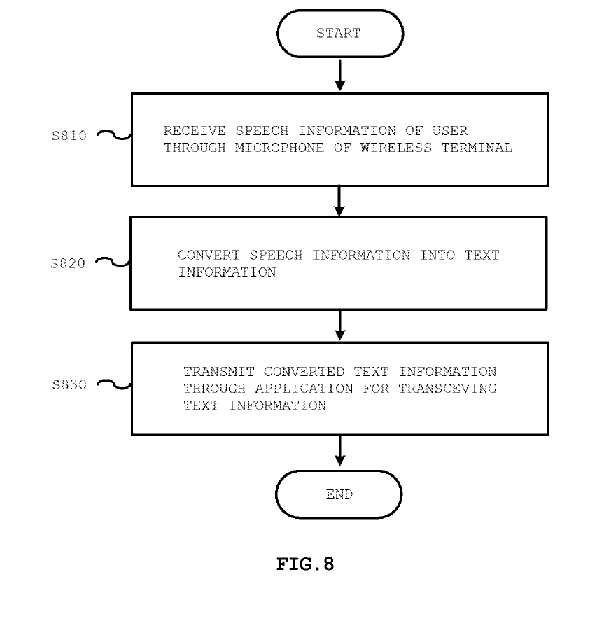

FIG. 8 shows the process for converting and transmitting a user's reply speech information into the text information, according to an embodiment of the present invention.

FIG. 8 shows the process for a case in which the user for the wireless terminal 100 transmits the reply to a counterpart for the speech information, that is, the text information transceiving terminal 120 transmitting the text information.

Firstly, the wireless terminal 100 receives speech information corresponding to the user's reply through a microphone included in the wireless terminal 100 by using the specific application or the input section 260 (S810).

Afterward, the wireless terminal 100 converts the received speech information into the text information by using the specific application or the converting section 245 (S820).

The converting section 245 may convert “haha” into the special character such as “̂̂”, that is, the text information included with the emotion on converting an onomatopoeia, that is, the speech information into the text information in case of including “haha” corresponding to the onomatopoeia of the received speech information, and may differ the size of the text converted according to the size of the speech such as the onomatopoeia.

Then, the wireless terminal 100 checks the text information transceiving application transmitting the converted text information by using the specific application or the processing section 250, and processes the converted text information to be transmitted to the text information transceiving terminal 120 by delivering the converted text information to the checked text information transceiving application or controlling the text information transceiving application (S830).

Here, the text information transceiving application transmitting the converted text information may be the text information transceiving application receiving the text information transmitted to the user's wireless terminal 100 before the user's reply.

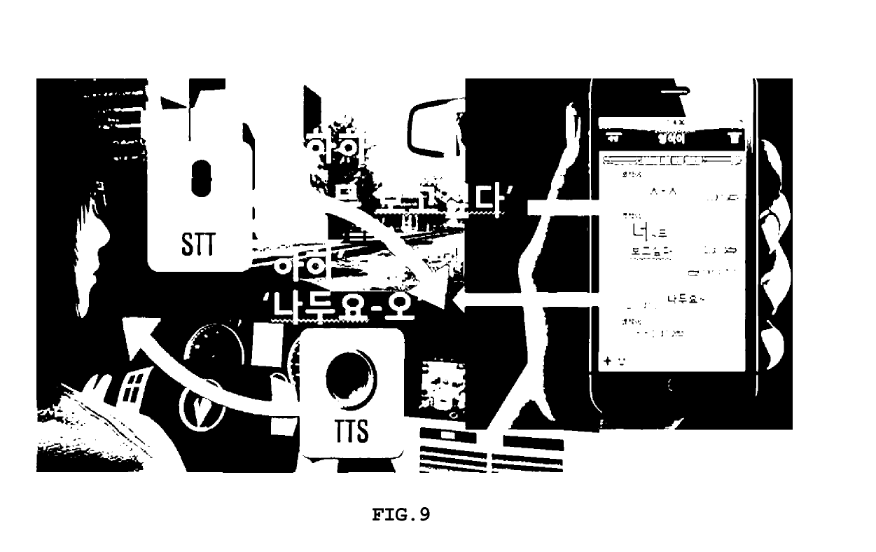

FIG. 9 shows one example according to the embodiment of the present invention.

As shown in FIG. 9, when a friend called Young-suck transmits the text information through a smartphone, the wireless terminal 100 of a user driving the vehicle converts the text information into the speech information to output through the speaker, and converts the reply speech information into the text information to transmit to the smartphone which the Young-suck belongs to.

A second embodiment of the present invention will be described. Wherein, for the convenience of the description, the part to be overlapped with the embodiment described above will be omitted.

FIG. 2 shows configurations of the wireless terminal 100 according to an embodiment of the present invention.

Referring to FIG. 2, the converting section 245 according to the present invention performs a role of converting the text information extracted or delivered through the extracting section 240 into speech information.

Also, in case the process of transmitting the reply speech information input by the user by text is added, the converting section 245 may further perform a role of converting the input speech information into text information if the speech information of the user's reply is input through the microphone included in the wireless terminal 100.

The processing section 250 according to the present invention processes the speech information converted through the converting section 245 such that the converted speech information is output through the speaker included in the wireless terminal 100.

Further, in case the process of transmitting the reply speech information input by the user by text is added, the processing section 250, if speech information corresponding to the user's reply is input through the microphone included in the wireless terminal 100 and the input speech information is converted into the text information by the converting section 245, transmits the converted text information to the text information transceiving terminal 120.

FIG. 8 shows the process for converting and transmitting a user's reply speech information into the text information, according to an embodiment of the present invention.

FIG. 8 shows the process for a case in which the user for the wireless terminal 100 transmits the reply to a counterpart for the speech information, that is, the text information transceiving terminal 120 transmitting the text information.

FIG. 8 may be applied to the case that a process of transmitting speech information of the user's reply to the speech information by text is added, shows the process for a case in which the user of the wireless terminal 100 transmits the reply to a counterpart for the speech information, that is, the text information transceiving terminal 120 transmitting the text information.

A third embodiment of the present invention will be described. Wherein, for the convenience of the description, the part to be overlapped with the embodiment described above will be omitted.

FIG. 1 shows configurations of the entire communication network according to an embodiment of the present invention.

In more detail, FIG. 1 shows the configurations that a user's wireless terminal 100 is connected to one or more text information relay servers 110 corresponding to a plurality of applications for transceiving text information through a network, receives text information transmitted from a text information transceiving terminal 120, checks whether the wireless terminal 100 is positioned in a vehicle by using connection of a short-range communication channel with a communication apparatus for the vehicle 130 over the short-range communication network, and then outputs the speech information converted from the text information through a communication apparatus 130 connected over the short-range communication network.

Referring to FIG. 1. the wireless terminal 100 according to the present invention checks whether the wireless terminal 100 is positioned in the vehicle by receiving connection information of the short-range communication channel between the wireless terminal 100 and the communication apparatus 130 from the communication apparatus 130 included in the vehicle, or receiving a signal corresponding to log-in information of the wireless terminal 100 from the communication apparatus 100 when the wireless terminal 100 logs in the communication apparatus 130, or paring a bluetooth device included in the wireless terminal 100 with a bluetooth device included in the vehicle, or receiving information whether the wireless terminal 100 is positioned in the vehicle directly from the communication apparatus 130, or receiving connection information of the wireless terminal's charger terminals to a power supply device included in the vehicle through the communication apparatus 130. And, then if the wireless terminal 100 is positioned in the vehicle, the wireless terminal 100 converts text information received through one among first to N-th text information transceiving applications installed in the wireless terminal 100 into speech information, outputs the converted speech information through a speaker equipped in the communication apparatus 130 (for example, a navigation device, telematics device or hands-free device, etc.) connected with the wireless terminal 100 using the short-range communication channel. And, if reply speech information is received by the communication apparatus 130 connected with the wireless terminal 100 using the short-range communication channel, after converting the received speech information into text information, the wireless terminal 100 transmits the converted text information to the text information transceiving terminal that transmitted the text information to the wireless terminal 100 through the text information transceiving application.

According to the present invention, the communication apparatus for the vehicle 130 is connected with the wireless terminal 100 using the short-range communication (for example, any short-range communication including Bluetooth communication and Wi-Fi communication, etc.). Therefore, the communication apparatus for the vehicle 130 may transmit the connection information of the short-range communication channel between the wireless terminal 100 and the communication apparatus 130 to the wireless terminal 100, or transmit a signal corresponding to log-in information to the wireless terminal 100 when the wireless terminal 100 logs in the communication apparatus 130, or transmit paring information between the bluetooth device included in the wireless terminal 100 and the bluetooth device included in the vehicle to the wireless terminal 100, or transmit information whether the wireless terminal 100 is positioned in the vehicle directly to the wireless terminal 100, or transmit connection information of the wireless terminal's charger terminals to a power supply device included in the vehicle to the wireless terminal 100 for checking whether the wireless terminal 100 positioned in the vehicle.

Also, the communication apparatus 130 performs a role of receiving the speech information that the text information received by the wireless terminal 100 is converted into through the short-range communication channel and outputting the received speech information, and another role of receiving the user's reply speech information corresponding to the speech information and then transmitting the received reply speech information to the wireless terminal 100.

According to the present invention, the communication apparatus for the vehicle 130 may comprise at least one of a telematics apparatus for the vehicle, an audio apparatus for the vehicle, a bluetooth device for the vehicle and a hands-free device for the vehicle.

FIG. 2 shows configurations of the wireless terminal 100 according to an embodiment of the present invention.

The processing section 250 according to the present invention processes the speech information converted through the converting section 245 such that the converted speech information is output through the communication apparatus 130 connected with the wireless terminal 100 using the short-range communication channel.

Further, the processing section 250, if speech information corresponding to the user's reply is received through the communication apparatus 130 connected with the wireless terminal 100 using the short-range communication channel and the received speech information is converted into the text information by the converting section 245, transmits the converted text information to the text information transceiving terminal 120.

The output section 255 according to the present invention transmits the speech information to the communication apparatus 130 included in the vehicle to be output, and the input section 260 receives the speech information from the communication apparatus 130.

According to the present invention, at least one of functions for each configuration disposed in the wireless terminal 100 may be implemented by an application that is a kind of a program installed in the wireless terminal 100.

In this case, the application may perform at least one of functions providing an interface for selecting one or more of the N applications for transceiving text information, storing and registering information of one or more applications selected by the wireless terminal's user through the interface in the memory 220, checking whether the wireless terminal 100 is positioned in the vehicle, deciding activation or deactivation of a function extracting the text information received by the text information transceiving application that is stored and registered in the memory 220. And, the application may further perform a function extracting the text information received by the text information transceiving application stored and registered in the memory 220 or receiving the text information from the text information transceiving application in case the text information is received to the first to N-th text information transceiving applications and the text information transceiving application is stored and registered in the memory 220. Also, the application may further perform at least one of functions converting the extracted or received text information into speech information, processing the converted speech information to be output through the communication apparatus 130 connected with the wireless terminal 100 using the short-range communication channel, receiving speech information of the wireless terminal's user through the communication apparatus 130, converting the received speech information into text information, and processing the converted text information to be transmitted through the text information transceiving application.

Hereinafter, each information processing process in the present invention will be described in more detail.

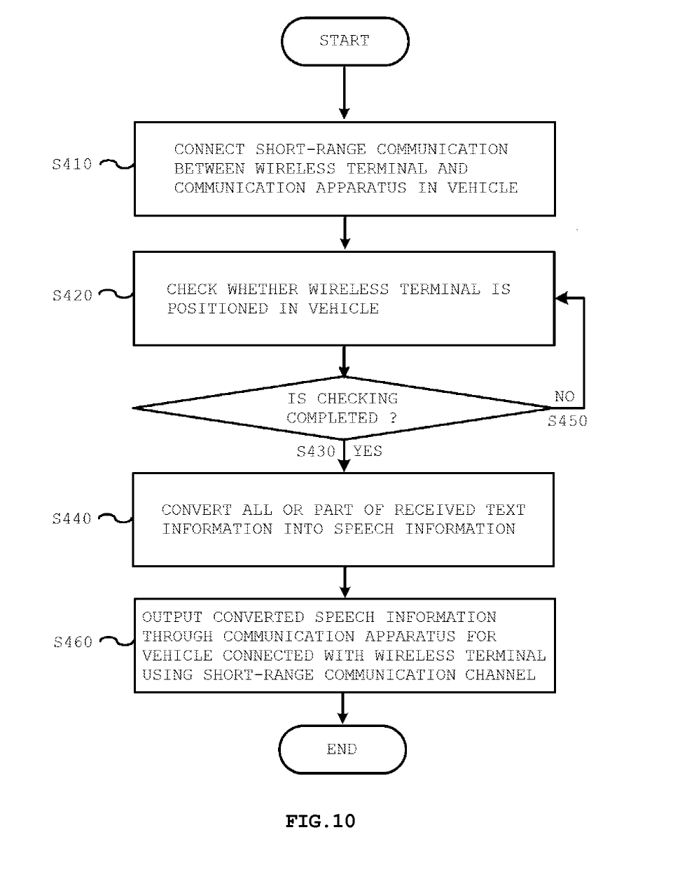

FIG. 10 shows a process for converting text the information into the speech information and outputting it, after checking whether the wireless terminal is located in the vehicle, according to an embodiment of the present invention.

Firstly, the wireless terminal 100 connects a short-range communication channel with the communication apparatus 130 included in the vehicle using the short-range communication (S410).

Then, the wireless terminal 100 checks whether the wireless terminal 100 is positioned in the vehicle (S420).

When it checks whether the wireless terminal 100 is positioned in the vehicle at the step S420 (S430), the wireless terminal 100 converts all or items corresponding to partial item information of text information received to the wireless terminal 100 into speech information (S440).

When it does not check whether the wireless terminal 100 is positioned in the vehicle at the step S420 (S450), the wireless terminal 100 outputs the text information received to the wireless terminal 100 on a screen.

Afterward, the wireless terminal 100 outputs the speech information converted in the step S440 through the hands-free device or the communication apparatus 130 in the vehicle using the short-range communication channel connected in the step 410 (S460).

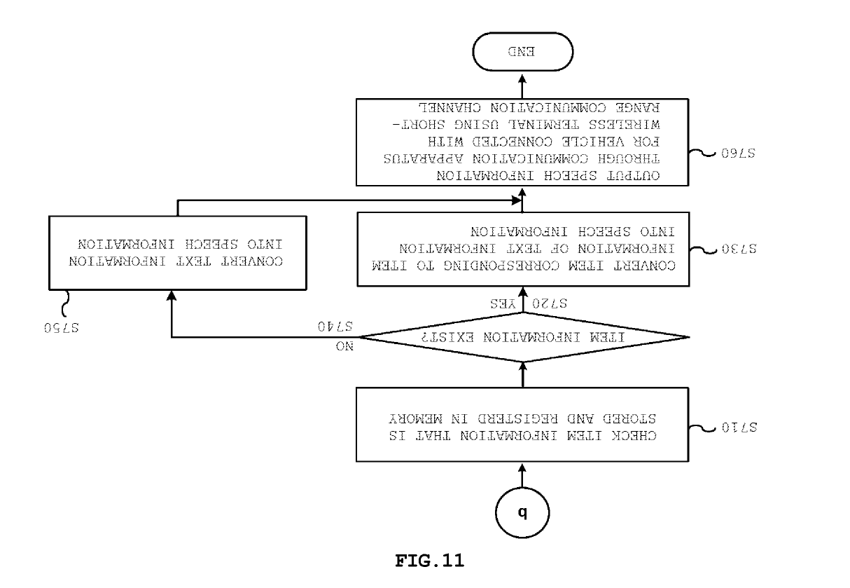

FIG. 11 shows a process for converting and outputting text information corresponding to pre-registered application information and item information into speech information, according to an embodiment of the present invention.

Firstly, the wireless terminal 100 checks Item information connected to the text information transceiving application pre-stored and registered in the memory 220 (S710).

If the item information exists (S720), the wireless terminal 100 converts only text information corresponding to the item information among the text information into speech information by using the specific application or the converting section 245 (S730).

If the item information does not exist (S740), the wireless terminal 100 converts all of the text information into speech information by using the specific application or the converting section 245 (S750).

Here, although not shown in the figure, the specific application or the converting section 245 may convert texts including emotion represented as various special characters such as “̂̂”, “˜˜”, “);;”, etc. of the text information into the speech information corresponding to the emotion, that is, “haha”. And, the converting section 245 may differ the size of the speech according to the size of the received text, on converting emotional expression including such a special character into the speech or text.

Afterward, the wireless terminal 100 outputs the converted speech information through the communication apparatus 130 in the vehicle connected with the wireless terminal 100 over the short-range communication channel by using the specific application or the processing section 250 (S760).

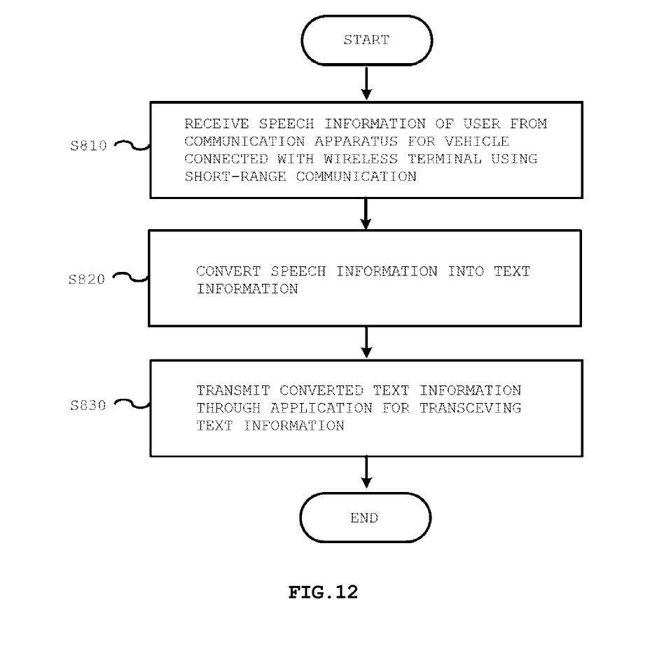

FIG. 12 shows a process for converting and transmitting a user's reply speech information into the text information, according to an embodiment of the present invention.

FIG. 12 shows the process for a case in which the user for the wireless terminal 100 transmits the reply to a counterpart for the speech information, that is, the text information transceiving terminal 120 transmitting the text information.

Firstly, the wireless terminal 100 receives speech information corresponding to the user's reply through the communication apparatus 130 connected with the wireless terminal 100 over the short-range communication channel, by using a specific application or the input section 260 (S810).

FIG. 9 shows one example according to the embodiment of the present invention.

As shown in FIG. 9, when a friend called Young-suck transmits the text information through a smartphone, the wireless terminal 100 of a user driving the vehicle converts the text information into the speech information to output through the communication apparatus 130 connected over the short-range communication channel, and converts the reply speech information into the text information to transmit to the smartphone which the Young-suck belongs to.

A fourth embodiment of the present invention will be described. Wherein, for the convenience of the description, the part to be overlapped with the embodiment described above will be omitted.

FIG. 1 shows configurations of the entire communication network according to an embodiment of the present invention.

In more detail, FIG. 1 shows the configurations that a user's wireless terminal 100 is connected to one or more text information relay servers 110 corresponding to a plurality of applications for transceiving text information through a network, receives text information transmitted from a text information transceiving terminal 120, checks whether the wireless terminal 100 is positioned in a vehicle by using connection of a short-range communication channel with a communication apparatus for the vehicle 130 over the short-range communication network, and then outputs the speech information converted from the text information through a communication apparatus 130 connected over the short-range communication network.

The wireless terminal 100 according to the present invention checks whether the wireless terminal 100 is positioned in the vehicle by receiving connection information of the short-range communication channel between the wireless terminal 100 and the communication apparatus 130 from the communication apparatus 130 included in the vehicle, or receiving a signal corresponding to log-in information of the wireless terminal 100 from the communication apparatus 100 when the wireless terminal 100 logs in the communication apparatus 130, or paring a bluetooth device included in the wireless terminal 100 with a bluetooth device included in the vehicle, or receiving information whether the wireless terminal 100 is positioned in the vehicle directly from the communication apparatus 130, or receiving connection information of the wireless terminal's charger terminals to a power supply device included in the vehicle through the communication apparatus 130. And, then if the wireless terminal 100 is positioned in the vehicle, the wireless terminal 100 converts text information received through one among first to N-th text information transceiving applications installed in the wireless terminal 100 into speech information, outputs the converted speech information through a speaker equipped in the communication apparatus 130 (for example, a navigation device, telematics device or hands-free device, etc.) connected with the wireless terminal 100 using the short-range communication channel.

If reply speech information is received by the communication apparatus 130 connected with the wireless terminal 100 using the short-range communication channel, after converting the received speech information into text information, the wireless terminal 100 transmits the converted text information to the text information transceiving terminal that transmitted the text information to the wireless terminal 100 through the text information transceiving application.

According to the present invention, the communication apparatus for the vehicle 130 is connected with the wireless terminal 100 using the short-range communication (for example, any short-range communication including Bluetooth communication and Wi-Fi communication, etc.). Therefore, the communication apparatus for the vehicle 130 may transmit the connection information of the short-range communication channel between the wireless terminal 100 and the communication apparatus 130 to the wireless terminal 100, or transmit a signal corresponding to log-in information to the wireless terminal 100 when the wireless terminal 100 logs in the communication apparatus 130, or transmit paring information between the bluetooth device included in the wireless terminal 100 and the bluetooth device included in the vehicle to the wireless terminal 100, or transmit information whether the wireless terminal 100 is positioned in the vehicle directly to the wireless terminal 100, or transmit connection information of the wireless terminal's charger terminals to a power supply device included in the vehicle to the wireless terminal 100 for checking whether the wireless terminal 100 positioned in the vehicle.

Also, the communication apparatus 130 performs a role of receiving the speech information that the text information received by the wireless terminal 100 is converted into through the short-range communication channel and outputting the received speech information.

According to the present invention, the communication apparatus for the vehicle 130 may comprise at least one of a telematics apparatus for the vehicle, an audio apparatus for the vehicle, a bluetooth device for the vehicle and a hands-free device for the vehicle.

FIG. 2 shows configurations of the wireless terminal 100 according to an embodiment of the present invention.

The wireless terminal 100 operated on mobile communication and communication system is applied to image processing according to the present invention, although a detailed illustration is omitted on FIG. 2, the wireless terminal 100 may include an outward body, a speaker, a microphone, a keypad, LCD (Liquid Crystal Display), an antenna, a battery, and all functions and elements that can be included in the wireless terminal 100 for communication the here and the hereafter.

Preferably, main functional components of the wireless terminal 100 according to the present invention, as shown in FIG. 2, may comprise an interface section 210, a registration section 215, a memory 220, a decision section 225, a communication section 230, a checking section 235, an extracting section 240, a converting section 245, a processing section 250, an output section 255, an input section 260, a short-range communication section 265 and a controller 200 controlling each of the components and a program. According to types and characteristics of the wireless terminal 100 and a skilled person's implement method, one or more components may be added or omitted.

For example, in case the function for conversion and outputting text information to speech information is equipped directly in one of the text information transceiving applications, the interface section 210, the registration section 215 and the extracting section 240 may be omitted.

The converting section 245 according to the present invention performs a role of converting the text information extracted or delivered through the extracting section 240 into speech information.

Also, in case the process of transmitting the reply speech information input by the user by text is added, the converting section 245 may further perform a role of converting the input speech information into text information if the speech information of the user's reply is received from the communication apparatus 130 connected with the wireless terminal 100 using the short-range communication.

Further, in case the process of transmitting the reply speech information input by the user by text is added, the processing section 250, if speech information corresponding to the user's reply is input through the communication apparatus 130 included in the vehicle and the input speech information is converted into the text information by the converting section 245, transmits the converted text information to the text information transceiving terminal 120.

The output section 255 according to the invention transmits the speech information to the communication apparatus 130 included in the vehicle so that the speech information is output, and the input section 260 receives the speech information from the communication apparatus 130 included in the vehicle.

According to the present invention, at least one of functions for each configuration disposed in the wireless terminal 100 may be implemented by an application that is a kind of a program installed in the wireless terminal 100.

In this case, the application may perform at least one of functions providing an interface for selecting one or more of the N applications for transceiving text information, storing and registering information of one or more applications selected by the wireless terminal's user through the interface in the memory 220, checking whether the wireless terminal 100 is positioned in the vehicle, deciding activation or deactivation of a function extracting the text information received by the text information transceiving application that is stored and registered in the memory 220. And, the application may further perform a function extracting the text information received by the text information transceiving application stored and registered in the memory 220 or receiving the text information from the text information transceiving application in case the text information is received to the first to N-th text information transceiving applications and the text information transceiving application is stored and registered in the memory 220. Also, the application may further perform at least one of functions converting the extracted or received text information into speech information, processing the converted speech information to be output through the communication apparatus 130 included in the vehicle connected with the wireless terminal 100 using the short-range communication.

Hereinafter, each information processing process in the present invention will be described in more detail.

FIG. 11 shows a process for converting and outputting text information corresponding to pre-registered application information and item information into speech information, according to an embodiment of the present invention.

Afterward, the wireless terminal 100 outputs the converted speech information through the communication apparatus 130 in the vehicle connected with the wireless terminal 100 over the short-range communication channel by using the specific application or the processing section 250 (S760).

FIG. 12 shows a process for converting and transmitting a user's reply speech information into the text information, according to an embodiment of the present invention.

FIG. 12 shows the process for a case in which the user for the wireless terminal 100 transmits the reply to a counterpart for the speech information, that is, the text information transceiving terminal 120 transmitting the text information.

FIG. 8 may be applied to the case that a process of transmitting speech information of the user's reply to the speech information by text is added, shows the process for a case in which the user of the wireless terminal 100 transmits the reply to a counterpart for the speech information, that is, the text information transceiving terminal 120 transmitting the text information.

Firstly, the wireless terminal 100 receives speech information corresponding to the user's reply transmitted from the communication apparatus 130 connected with the wireless terminal 100 over the short-range communication channel, by using the specific application or the input section 260 (S810).

FIG. 9 shows one example according to the embodiment of the present invention.

As shown in FIG. 9, when a friend called Young-suck transmits the text information through a smartphone, the wireless terminal 100 of a user driving the vehicle converts the text information into the speech information to output through the communication apparatus 130 connected over the short-range communication channel, and converts the reply speech information into the text information to transmit to the smartphone which the Young-suck belongs to.

1. A wireless terminal, comprising:
a short-range communication section for connecting a short-range communication channel with a communication apparatus included in a vehicle;
a checking section for checking whether the wireless terminal is positioned in the vehicle, based on connection information of the short-range communication channel through the short-range communication section;
a first converting section for converting text information received through one of N applications for transceiving text information into speech information, the applications being included in the wireless terminal, in case the wireless terminal is positioned in the vehicle, according to a result of the checking by the checking section;
a processing section for outputting the converted speech information through a speaker of the wireless terminal;
an input section for receiving speech information from a user of the wireless terminal; and
a second converting section for converting the received speech information into text information,
wherein the processing section transmits the converted text information through the application for transceiving text information.

2. The wireless terminal according to claim 1, wherein the checking section is activated when the text information is received thorough one of the applications for transceiving text information.

3. The wireless terminal according to claim 1, wherein the checking section checks whether the wireless terminal is positioned in the vehicle by receiving connection information of the short-range communication channel between the wireless terminal and the communication apparatus from the communication apparatus included in the vehicle, or
receiving a signal corresponding to log-in information of the wireless terminal from the communication apparatus when the wireless terminal logs in the communication apparatus, or
paring a bluetooth device included in the wireless terminal with a bluetooth device included in the vehicle, or
receiving information whether the wireless terminal is positioned in the vehicle from the communication apparatus, or
receiving connection information of the wireless terminal's charger terminals to a power supply device included in the vehicle through the communication apparatus.

4. The wireless terminal according to claim 1, further comprising:
an interface section for providing an interface for selecting one or more of the N applications for transceiving text information, the applications being included in the wireless terminal;
a registration section for storing and registering information of one or more applications that the wireless terminal's user selects through the interface section in a memory; and
an extraction section for extracting text information received by the application stored and registered in the memory or receives the text information from the application, in case the application receiving the text information is already stored and registered in the memory.

5. The wireless terminal according to claim 4, wherein the interface section receives a selection of item to be converted into speech information among text information received by the selected application,
the registration section further connects information of the item selected through the interface section with information of the selected application, and stores and registers the connected information in the memory;
the extraction section checks the item information connected with the selected application in the memory, and selectively extracts or receives text information corresponding to the item information;
the item information includes at least one of message transmitter information and message content information in case the application is a message transceiving application including one or more of SMS(Short Message Service), LMS (Long Message Service) and MMS (Multimedia Message Services), includes at least one of e-mail transmitter information, e-mail title information and e-mail body content information in case the application is an application for transceiving e-mail, and includes at least one of messenger user information and messenger content information in case the application is an instant messenger application.

6. The wireless terminal according to claim 1, wherein the first and second converting sections are same component or separate components.

7. The wireless terminal according to claim 1, wherein the application for transceiving text information includes at least one of:
a message transceiving application including one or more of SMS(Short Message Service), LMS (Long Message Service) and MMS (Multimedia Message Services),
an e-mail transceiving application,
an instant messenger application, and
a SNS(Social Networking Service) application.

8. The wireless terminal according to claim 1, wherein the text information includes at least one of message transmitter information and message content information in case the application is a message transceiving application including one or more of SMS(Short Message Service), LMS (Long Message Service) and MMS (Multimedia Message Services), includes at least one of e-mail transmitter information, e-mail title information and e-mail body content information in case the application is an application for transceiving e-mail, includes at least one of messenger user information and messenger content information in case the application is an instant messenger application, and includes at least one of SNS user ID information and content information in case the application is an SNS application.

9. An image processing method in a wireless terminal, comprising:
connecting a short-range communication channel with a communication apparatus included in a vehicle;
checking whether the wireless terminal is positioned in a vehicle, based on connection information of the short-range communication channel through the connecting;
converting text information received through one of N applications for transceiving text information into speech information, the applications being included in the wireless terminal, in case the wireless terminal is positioned in the vehicle, according to a result of the checking by the checking section;
outputting the converted speech information through a speaker of the wireless terminal;
receiving speech information from a user of the wireless terminal;
converting the received speech information into text information; and
transmitting the converted text information through the application for transceiving text information.

10. The image processing method according to claim 9, further comprising:
checking whether the text information is received through one of the N applications for transceiving text information,
wherein whether the wireless terminal is positioned in the vehicle is checked according to a result of the checking.

11. The image processing method according to claim 9, wherein the checking checks whether the wireless terminal is positioned in the vehicle by receiving connection information of the short-range communication channel between the wireless terminal and the communication apparatus from the communication apparatus included in the vehicle, or
receiving a signal corresponding to log-in information of the wireless terminal from the communication apparatus when the wireless terminal logs in the communication apparatus, or
paring a bluetooth device included in the wireless terminal with a bluetooth device included in the vehicle, or
receiving information whether the wireless terminal is positioned in the vehicle from the communication apparatus, or
receiving connection information of the wireless terminal's charger terminals to a power supply device included in the vehicle through the communication apparatus.

12. The image processing method according to claim 9, further comprising:
providing an interface for selecting one or more of the N applications for transceiving text information, the applications being included in the wireless terminal;
storing and registering information of one or more applications that the wireless terminal's user selects through the interface section in a memory; and
extracting text information received by the application stored and registered in the memory or receives the text information from the application, in case the application receiving the text information is already stored and registered in the memory.

13. The image processing method according to claim 12, wherein the providing receives a selection of item to be converted into speech information among text information received by the selected application,
the storing and registering connects information of the item selected through the interface section with information of the selected application, and stores and registers the connected information in the memory, and
the extracting checks the item information connected with the selected application in the memory, and selectively extracts or receives text information corresponding to the item information.

14. A computer-readable recording medium for recording programs to execute the method of claim 9.

15-54. (canceled)
